(19) United States
(12) Patent Application Publication
(10) Pub. No.: US 2025/0297683 A1
(43) Pub. Date: Sep. 25, 2025

(54) Adapter for Connecting an Actuator to a Manually Operable Shut-Off Valve and System Comprising Such an Adapter and a Manually Operable Shut-Off Valve

(71) Applicant: Viega Technology GmbH & Co. KG, Attendorn (DE)

(72) Inventor: Daniel Effertz, Attendorn (DE)

(21) Appl. No.: 19/083,913

(22) Filed: Mar. 19, 2025

(30) Foreign Application Priority Data
Mar. 20, 2024 (DE) 10 2024 107 975.4

(51) Int. Cl. F16K 5/06; F16K 31/05

(52) U.S. Cl. CPC F16K 5/0647; F16K 31/055

(57) ABSTRACT

The invention relates to an adapter for connecting a actuator to a manually operable shut-off valve, in particular a ball valve, with a flange, with a fastening section formed on the flange for fastening the actuator and with a square adapter for transmitting a torque from the actuator to the control shaft of the shut-off valve. The flange has a flange ring and an insert arranged in the flange ring, the flange ring and the insert being arranged along the axis of the control shaft, in that the insert has an internal opening with an internal cross-section adapted to an external dimension of the shut-off valve, in that the insert is designed as a ring which is open in the azimuthal direction and can be compressed radially, that the flange ring and the insert have conical contact surfaces corresponding to one another and that screw means are provided for tightening the flange ring and the insert in the axial direction relative to one another in order to reduce the internal diameter of the internal opening. This solves the problem of specifying an adapter and a system of the type mentioned above, which extends existing installations and, in particular, is easy to position and assemble,

### CROSS-REFERENCE TO RELATED APPLICATION

This application claims priority to German Patent Application No. 10 2024 107 975.4 filed Mar. 20, 2024, the disclosure of which is hereby incorporated by reference in its entirety.

### BACKGROUND OF THE INVENTION

### Field of the Invention

The invention relates to an adapter for connecting an actuator to a manually operable shut-off valve, in particular a ball valve. Furthermore, the invention relates to a system comprising such an adapter and a manually operable shut-off valve.

### Description of Related Art

Shut-off valves with a manually or automatically operable circuit for blocking or releasing the flow of fluids in a pipeline are known from the state of the art.

Manually operable shut-off valves are usually connected to other pipes in pipelines by means of fittings connected at both ends and have a hand lever mounted on a control shaft for releasing and blocking the flow. The position of the hand lever for releasing or blocking the flow is often determined by stop cams integrated in or on the housing, the arrangement of which corresponds to the positions mentioned. To release or block the flow, the hand lever is moved back and forth between the stop cams. In most cases, manually operable shut-off valves can be set to the release and blocking positions, although intermediate positions, i.e. positions of the hand lever between the stop cams, are also possible. In most cases, precise adjustment of the flow rate can only be achieved in the release and blocking positions of the shut-off valve, as finer control of the flow rate can often not be realised in a precise and reproducible manner due to the switching with a hand lever. Generally, the release and shut-off positions differ from each other by 90° of rotation.

Ball valves are widely used, in which a ball with a bore is arranged in a housing to form a seal, which can be rotated using the hand lever and the control shaft connected to it. The hole in the ball enables a flow when it is connected to the inlet and outlet lines in terms of flow. The flow rate is maximised when the axis of the hole coincides with the flow direction of the inlet and outlet. If, on the other hand, the ball is orientated at 90° to this position, the flow is blocked.

Automatically actuated shut-off valves utilise an adjustable actuator that drives the switching shaft of the shut-off valve when switching between blocking and releasing the flow. To ensure safe installation of the actuator on the shut-off valve, these shut-off valves are already designed in an integrated design with a connection flange or a connection point for an actuator with a flange in accordance with the DIN ISO 5211 standard. The connecting flange or the connection point for a flange for mounting an actuator is designed into the body of the shut-off valve and is already installed or integral with it. Accordingly, the housing of an automatically operated shut-off valve already has an interface for the controllable actuator.

In the course of modernising buildings, their degree of automation is usually to be increased. Often, pipework installations also need to be automated and therefore equipped with an adjustable actuator. At present, this means that the manually operable shut-off valves installed in existing systems in a pipework installation are replaced by automatically operable shut-off valves, i.e. shut-off valves that are already designed as an integrated component. This measure is necessary regardless of how modern the installation is. When modernising the installation of piping systems in this way, a complete new purchase of automatically operable shut-off valves is unavoidable and involves increased costs.

### SUMMARY OF THE INVENTION

Based on this, the invention is based on the task of specifying an adapter and a system of the type mentioned at the beginning, which extends existing installations and, in particular, is easy to position and mount.

The above task is solved in accordance with the invention by an adapter mentioned at the beginning for connecting an actuator to a manually operable shut-off valve, in particular a ball valve, with a flange, with a fastening section formed on the flange for fastening the actuator and with a square adapter for transmitting a torque from the actuator to the switching shaft of the shut-off valve, wherein the flange has a flange ring and an insert arranged in the flange ring, wherein the insert has an internal opening with an internal cross-section adapted to an external dimension of the shut-off valve, wherein the insert is designed as a ring that is open in azimuthal direction and can be compressed radially, wherein the flange ring and the insert have corresponding conical contact surfaces and wherein screw means are provided for bracing the flange ring and the insert in axial direction relative to one another in order to reduce the internal diameter of the internal opening.

Preferably, the flange ring and the insert are arranged along the axis of the switching shaft of the shut-off valve in the assembled state. Preferably, a ball valve as described at the beginning is used as the shut-off valve. Reference is made here to this description.

When the adapter is mounted, the screw means are tightened, and the inner diameter of the insert is reduced due to the conical contact surfaces between the flange ring and the insert. This is because the insert has an open ring shape, which can also be described as a C-shape and can therefore be compressed in azimuthal direction and reduced to a smaller diameter.

As a result, the inside of the insert comes into contact with the outer contour of the shut-off valve and is secured against movement relative to the shut-off valve by further tightening of the screw means. This is because the resulting static friction between the insert and the outer contour of the shut-off valve is sufficient to secure the position of the insert and therefore also the flange ring in relation to the shut-off valve.

This means that a torque from an actuator attached with the flange, such as an electric motor, can be transmitted to the switching shaft of the shut-off valve via the flange using the square adapter.

The fastening section formed on the flange can be adapted to the above-mentioned DIN ISO 5211 standard by means of fastening means such as holes with or without threads, so that standardised actuators can be used with shut-off valves designed only for manual operation without having to replace the shut-off valves.

The flange described therefore enables secure and backlash-free installation of an ISO flange as a retrofit solution for existing and already installed shut-off valves. Installation is accessible from the operating side of the shut-off valve, so that lateral installation, which is usually made more difficult by additional pipework and insulation, can be avoided. In addition, the design is very compact and hardly adds any height.

Preferably, the screw means can have at least two internal threads in the flange ring, at least two blind holes, each having a shoulder, in the insert and at least two grub screws. The grub screws are moved axially during screwing in and are each supported on one of the shoulders in the insert from a predetermined screwing-in depth. By tightening the screw means, the insert is moved axially in relation to the flange ring, thus generating a tightening force on the insert, which causes the insert to press against the shut-off valve as described.

It is also advantageous if the internal threads are designed as laterally open partial threads, and the blind holes are designed as laterally open partial openings in the region of the conical contact surfaces. The partial threads and the blind holes are aligned to each other so that the flange ring is axially symmetrical to the direction of flow. The blind holes can be shifted towards each other when the insert is pressed to a smaller diameter of the insert without blocking further screwing in of the screw means.

The aim is for the flange ring to have a defined position in relation to the ball valve, just like ball valves with an integral flange. The compensation of the diameter is only minimal, so it is sufficient if the blind hole is chosen to be slightly larger. In addition to the alignment, the arrangement with partial thread and partial blind holes has the advantage that the design is very compact for applying the force and then moving the insert.

To release the adapter arrangement, it is advantageous if the insert can be pressed out of the flange ring again. For this purpose, preferably, the insert has an internal thread for receiving a grub screw and the flange ring has a blind hole corresponding to the internal thread. When the grub screw is screwed in, the front end of the grub screw comes into contact with the bottom of the blind hole and when the grub screw is screwed in further, a force is generated that pushes the insert out of the flange ring.

As with the other partial threads and blind holes, the internal thread and the blind hole can be laterally open in the region of the conical contact surfaces and occupy positions corresponding to each other. This arrangement also has the advantage in this case that the insert can move to a larger diameter in relation to the flange ring during expansion without the two partial openings blocking with the grub screw.

Furthermore, it is preferable that the internal cross-section of the internal opening of the insert has radially outward-facing directed recesses for receiving stop cams arranged on the outside of the shut-off valve. Thus, in addition to pressing the insert against the outer contour of the shut-off valve, a further anti-rotation lock is created. Furthermore, the insert and thus the entire adapter is aligned relative to the shut-off valve, so that improved positioning accuracy of the adapter and thus also of the actuator relative to the shut-off valve can be guaranteed.

Furthermore, the inner cross-section of the internal opening of the insert can advantageously have a, in particular semi-circular, recess formed in axial direction of the switching shaft of the shut-off valve to be received, with two stops for the rotary movement of the square adapter, and the square adapter can have a quarter-circular radially protruding flange. This further improves the positioning of the adapter and the actuator; the two end positions for an open shut-off valve and a closed shut-off valve can be set by the assembly itself. This means that no stops need to be set on the actuator, as the stops of the insert and the square adapter are utilised by the direct transfer of the stop from the shut-off valve.

The above task is solved according to the invention by a system with an adapter of the type described above and with a manually operable shut-off valve, wherein the shut-off valve has an outer contour corresponding to the inner contour of the insert of the flange.

The features and advantages described above for the adapter also apply equally to the system according to the invention.

### BRIEF DESCRIPTION OF THE DRAWINGS

In the following, the invention is explained with reference to the drawing by means of examples of embodiments. The drawing shows:

FIGS. 1-3 a flange ring of an adapter according to the invention in different views,

FIGS. 4-6 an insert of an adapter according to the invention in different views,

FIGS. 7-9 a square adapter of an adapter according to the invention in different views,

FIGS. 10-11 a screw for fastening the square adapter according to FIGS. 7-9 in different views,

FIGS. 12-14 A pre-assembled adapter on a ball valve in different views,

FIGS. 15-16 an adapter attached to the ball valve in different views and

FIG. 17 an adapter prepared for a loosening.

### DESCRIPTION OF THE INVENTION

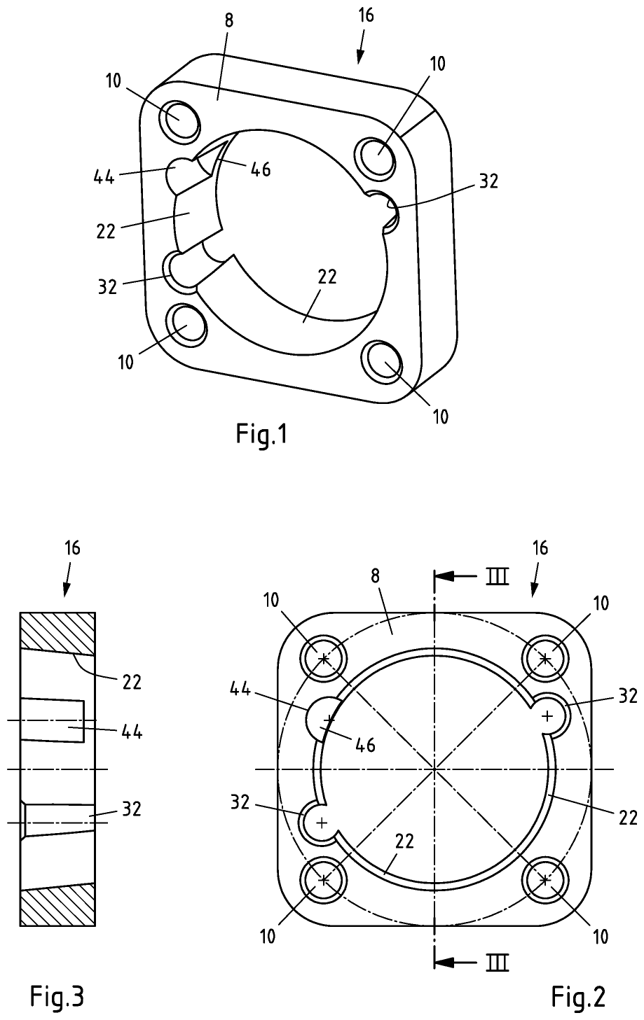

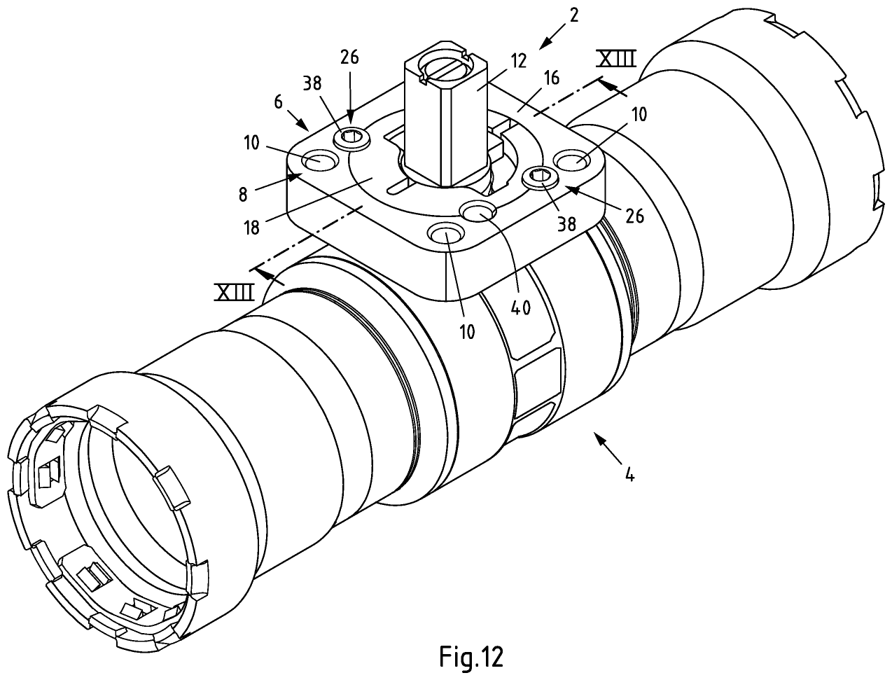

The following describes in detail an example embodiment of an adapter 2 according to the invention for connecting an actuator (not shown) to a manually operable shut-off valve, which in this case is designed as a ball valve 4. FIGS. 1 to 11 show individual components of the adapter 2, while FIGS. 12 to 17 show the adapter 2 in various stages of assembly with a ball valve 4.

FIGS. 12 to 14 show the adapter 2 in a pre-assembled position on a ball valve 4, which is connected to known fittings on both sides. The adapter 2 has a flange 6 on which there is a fastening section 8 with four holes 10 for fastening the actuator. The holes 10 are arranged in such a way that various actuators can be fastened to them, in particular the holes 10 are arranged in accordance with the DIN ISO 5211 standard. The holes 10 either have an internal thread or are designed as through holes.

Furthermore, a square adapter 12 is provided for transmitting a torque from the actuator to the switching shaft 14 of the ball valve 4. The dimensions of the square adapter 12 are designed in accordance with DIN EN ISO 5211.

The flange 6 has a flange ring 16 and an insert 18 arranged in the flange ring 16, the flange ring 16 and the insert 18 being arranged along the axis A of the switching shaft 14.

Furthermore, the insert 18 has an internal opening 20 with an internal cross-section adapted to an external dimension of the ball valve 4, whereby the insert 18 is designed as a ring that is open in azimuthal direction and can be compressed radially.

The flange ring 16 and the insert 18 have corresponding conical contact surfaces 22 and 24, and screw means 26 are provided for bracing the flange ring 16 and the insert 18 in axial direction relative to one another in order to reduce the internal diameter of the internal opening 20.

By tightening the screw means 26, the insert 18 is pulled into the flange ring 16 and pressed together on the circumference. This secures the flange 6 as a whole against movement relative to the ball valve.

FIGS. 1-3 show the flange ring 16 in detail with the holes 10 of the fastening section 8 and the conically shaped contact surface 22.

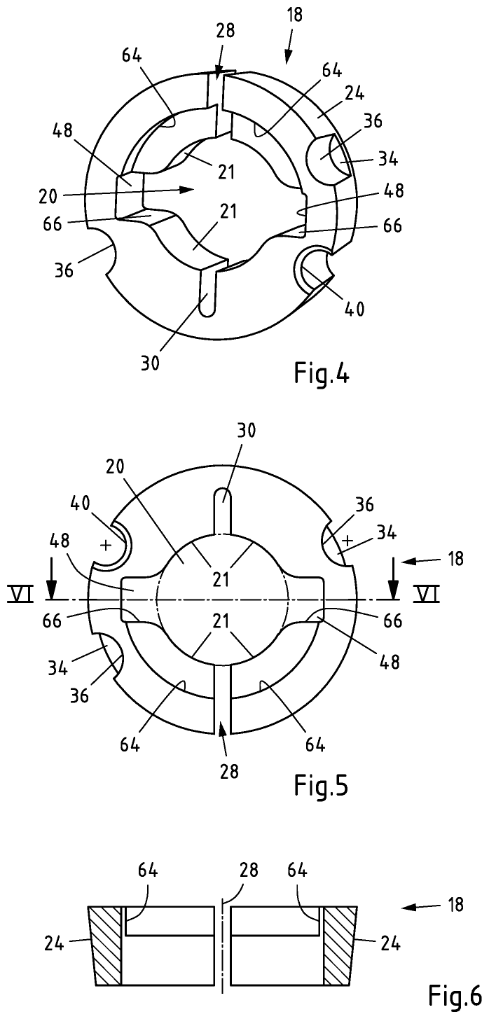

FIGS. 4-6 show the insert 18 in detail with the internal opening 20 with the circumferential inner surfaces 21 and the conically shaped contact surface 24. The insert 18 has an opening 28, opposite which a recess 30 is formed. The insert 18 is thus designed as a ring that is open in azimuthal direction and can be compressed radially.

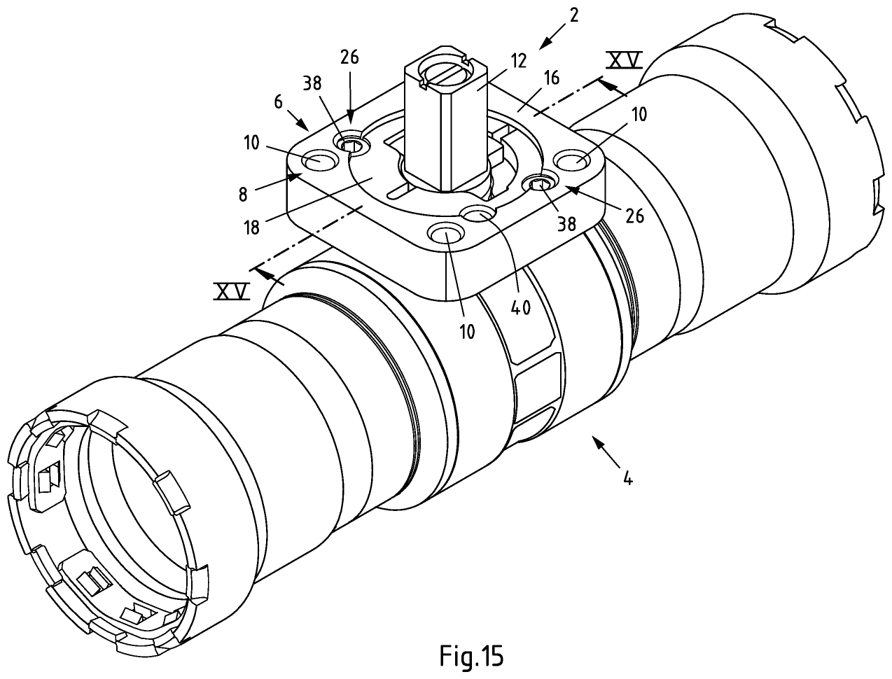

To create the fixed connection of the flange ring 16 and the insert 18 on the outer dimension of the ball valve 4, the screw means 26 have two internal threads 32 in the flange ring 16, two blind holes 36 in the insert 18, each having a shoulder 34, and two grub screws 38, preferably with an internal hexagon, which can be seen in FIGS. 12 and 15. The internal threads 32 are designed as laterally open partial threads and the blind holes 36 as laterally open partial openings in the region of the conical contact surfaces 22 and 24.

Furthermore, the insert 18 has an internal thread 40 for receiving a grub screw 42, which is shown in FIG. 17. Accordingly, the flange ring 16 has a blind hole 44 corresponding to the internal thread 40, on the base surface 46 of which the grub screw 42 is supported when the grub screw is screwed sufficiently far into the internal thread 40.

Here too, the internal thread 40 and the blind hole 42 are laterally open in the region of the conical contact surfaces 22 and 24.

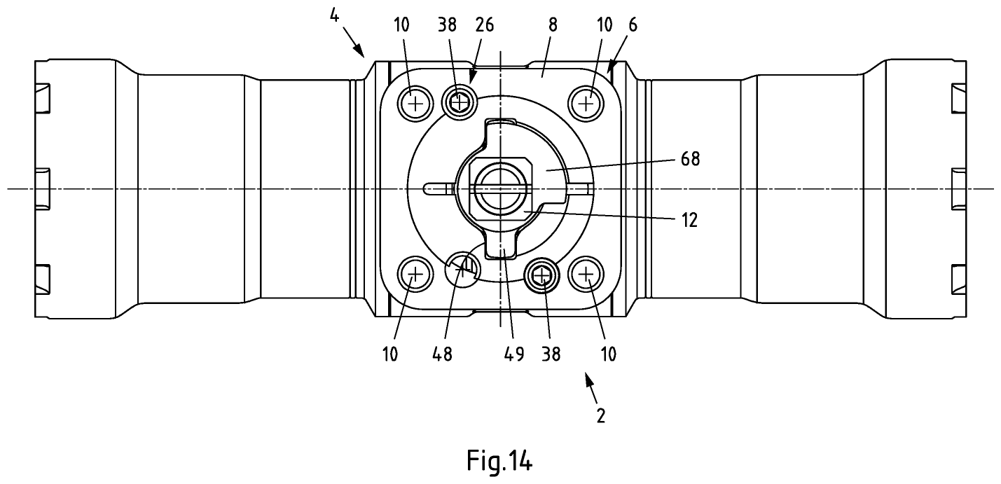

The inner cross-section of the internal opening 20 of the insert 18 also has radially outward-facing recesses 48 for receiving stop cams 49 arranged on the outside of the ball valve 4, as can be seen in a plan view in FIG. 14. This allows the insert 18 to be arranged and fastened to the ball valve 4 so that it cannot rotate.

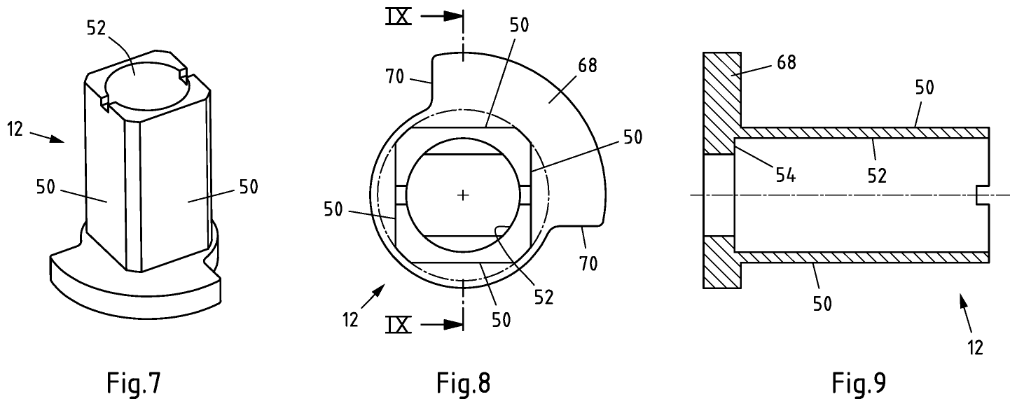

The square adapter 12 is designed as shown in FIGS. 7 to 9 and has four side surfaces 50, which are aligned at right angles to each other. The dimensions of the square adapter 12 are selected in accordance with DIN EN ISO 5211. This means that an actuator with a corresponding square mount can be connected to the square adapter. A round through-opening 52 is formed inside the square adapter 12 in order to place the square adapter 12 on the switching shaft 14 of the ball valve 4. At the end of the square adapter 12 facing the switching shaft 14, a circumferential and inwardly directed shoulder 56 is formed, the internal cross-section of which is adapted to the external dimensions of the switching shaft 14.

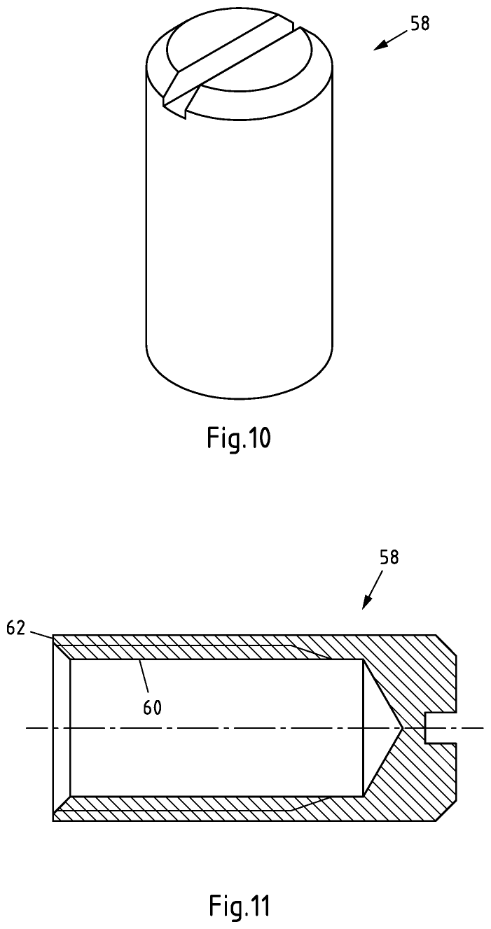

Furthermore, a screw 58 as shown in FIGS. 10 and 11 is provided, which is sleeve-shaped and has an internal thread 60 that co-operates with the external thread of the switching shaft 14.

When the screw 58 is screwed in, the front end 62 comes into contact with the shoulder 54 of the square adapter 12 and fixes the square adapter 12 in relation to the switching shaft 14. This secures the adapter 2 in axial direction in relation to the ball valve 4.

A further special embodiment of the insert 18 is that the inner cross-section of the internal opening 20 of the insert 18 has a, in particular semicircular, recess 64 formed in axial direction of the switching shaft 14 of the ball valve 4 to be received, with two stops 66 for the rotary movement of the square adapter 12, and that the square adapter 12 has a quarter-circular radially protruding flange 68 with two stops 70, as shown in particular in FIGS. 7 to 9.

This creates a system with an adapter 2 as shown in FIGS. 1 to 11 and with a manually operable shut-off valve or ball valve 4, wherein the ball valve 4 has an outer contour corresponding to the inner contour of the insert 18 of the flange 6.

FIGS. 12 to 17 show the assembly and disassembly of the adapter 2.

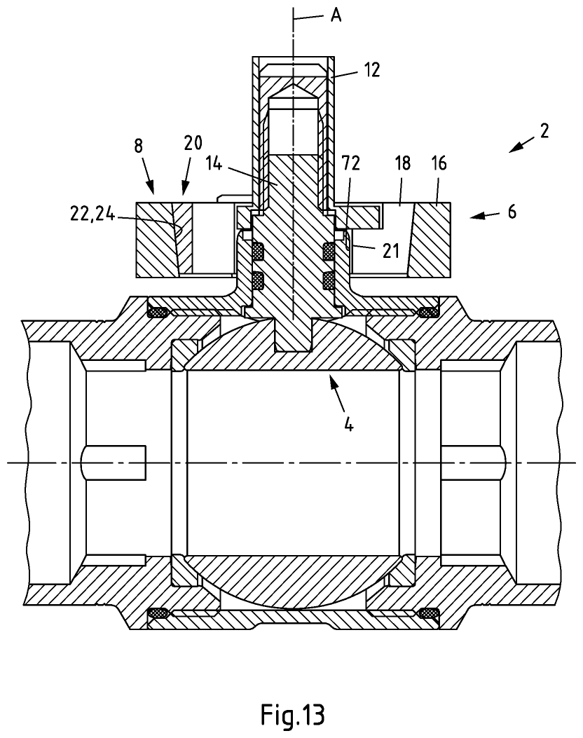

As shown in FIGS. 12 to 14, the adapter 2 is positioned on the switching shaft 14 of the ball valve 4 and held in place manually if necessary. The threaded screws 38 are partially screwed in and protrude slightly upwards. The cross-section in FIG. 13 shows that the inner surface 21 of the insert 18 has a small radial distance to the outer surface 72 of the ball valve 4. The pre-assembled adapter 2 can therefore be placed on the ball valve 4 and moved for positioning.

To fasten the adapter 2, the threaded screws 38 are tightened evenly, alternately if necessary. The threaded screws 38 rotate in the internal threads 32 of the flange ring 16 and press the insert 18 into contact with the shoulders 34 of the blind holes 36.

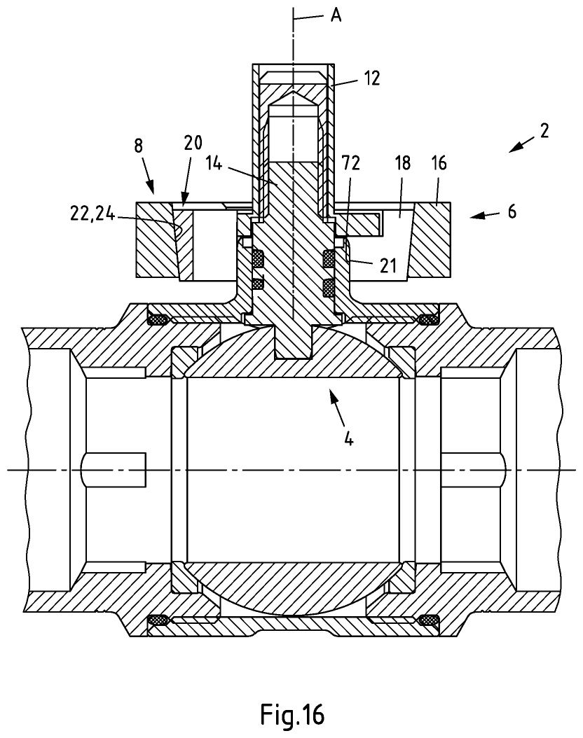

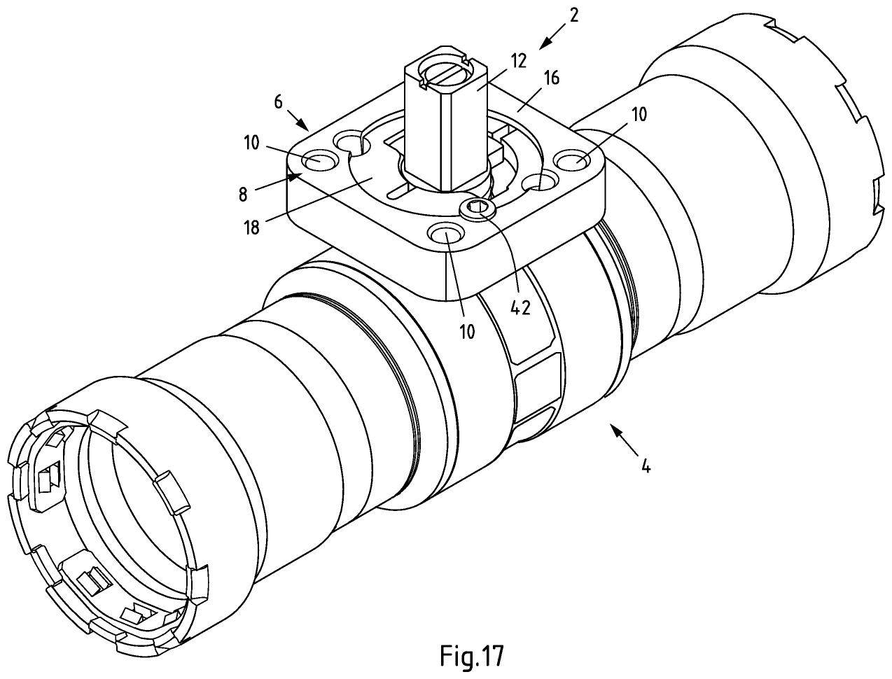

As described, this pulls the insert 18 into the flange ring 16. The insert 18 is compressed by the conical contact surfaces 22 and 24 and the inside diameter of the inner surfaces 21 is reduced. As a result, the internal opening 20 is pressed against the outside 72 of the ball valve 4. This state is shown in FIGS. 15 and 16. This results in the adapter 2 being self-retaining on the ball valve 4. The further assembly of the square adapter 12 with the screw 58 can then take place in order to prepare the fastened adapter 2 for a connection of the actuator.

FIG. 17 shows the state prepared for loosening the adapter 2. The threaded screw 42 is partially screwed into the internal thread 40 and the blind hole 44. To release the adapter, the threaded screw 42 is tightened and rests against the base surface 46 of the blind hole 44 so that the insert 18 is pulled out of the flange ring 16 and released. The detached adapter 2 can then be removed from the ball valve 4.

1. An adapter for connecting an actuator to a manually operable shut-off valve, in particular a ball valve,
with a flange,
with a fastening section formed on the flange for fastening the actuator and
with a square adapter for transmitting a torque from the actuator to the switching shaft of the shut-off valve,
wherein
the flange has a flange ring and an insert arranged in the flange ring
the insert has an internal opening with an internal cross-section adapted to an external dimension of the shut-off valve,
the insert is designed as a ring that is open in azimuthal direction and can be compressed radially,
the flange ring and the insert have corresponding conical contact surfaces and
screw means are provided for bracing the flange ring and the insert in axial direction relative to one another in order to reduce the internal diameter of the internal opening.

2. The adapter according to claim 1, wherein
the screw means have at least two internal threads in the flange ring, at least two blind holes, each having a shoulder, in the insert and at least two grub screws.

3. The adapter according to claim 2, wherein
the internal threads are designed as laterally open partial threads and the blind holes are designed as laterally open partial openings in the region of the conical contact surfaces.

4. The adapter according to claim 1,
wherein
the insert has an internal thread for receiving a grub screw and
the flange ring has a blind hole corresponding to the internal thread.

5. The adapter according to claim 4, wherein
the internal thread and the blind hole are laterally open in the region of the conical contact surfaces.

6. The adapter according to claim 1,
wherein
the internal cross-section of the internal opening of the insert has radially outward-facing directed recesses for receiving stop cams arranged on the outside of the shut-off valve.

7. The adapter according to claim 1,
wherein
the inner cross-section of the internal opening of the insert has a, in particular semicircular, recess formed in axial direction of the switching shaft of the shut-off valve to be received, with two stops for the rotary movement of the square adapter, and
the square adapter has a quarter-circular radially protruding flange.

8. A system
with an adapter according to claim 1 and
with a manually operable shut-off valve,
wherein the shut-off valve has an outer contour corresponding to the inner contour of the insert of the flange.
